(19) United States
(12) Patent Application Publication
(10) Pub. No.: US 2009/0320880 A1
(43) Pub. Date: Dec. 31, 2009

(54) METHOD AND SYSTEM FOR CLEANING FILTERS

(75) Inventor: Lars-Göran Håkansson, Malmo (SE)

Correspondence Address: YOUNG & THOMPSON, 209 Madison Street, Suite 500, Alexandria, VA, 22314, US

(73) Assignee: UBD CLEANTECH AKTIEBOLAG, Svedala (SE)

(21) Appl. No.: 12/524,449

(22) PCT Filed: Jan. 24, 2008
(86) PCT No.: PCT/SE08/50082

§ 371 Date: Jul. 24, 2009

(30) Foreign Application Priority Data
Jan. 24, 2007 (SE) 0700173-8
Jun. 11, 2007 (SE) 0701416-0

(51) Int. Cl. G01N 7/00; B01D 41/04; G01N 1/22; B01D 50/00; B01D 41/00; B01D 46/42

(52) U.S. Cl. 134/18; 134/20; 73/23.31; 73/863.23; 96/423; 96/421; 96/416

(57) ABSTRACT

A method of cleaning a particle filter, in particular for combustion engines, includes the steps of: —a) applying heat to the interior of the particle filter during a certain time period for burning the trapped particles, —b) removing the burnt particles from the particle filter, —c) measuring the particle filter, wherein the measurements are compared to values of a unused filter of the particular type, and—if the measured values deviate from the values of the unused filter by a predetermined amount, steps a) to c) are repeated until the measured values are within an approval range. A system for performing the method is also disclosed.

### TECHNICAL AREA

The present invention relates to a method and system for cleaning filters, and in particular filters for exhaust particles from combustion engines. The present invention also relates to methods for measuring the cleaning result.

### TECHNICAL BACKGROUND

There is an increasing demand on the environmental aspects of pollution to decrease the negative effects and thus the amount of pollution. One source of pollution of the environment is exhaust gases from combustion engines in vehicles such as cars, lorries, buses and the like.

The exhaust gases have become less harmful during the last two decades thanks to more advanced emission control and catalysts. Also diesel engines have become cleaner thanks to catalysts. During recent years, many diesel powered engines have also been equipped with particle filters, for further reducing the amount of pollutants in the exhaust gases.

The particle filters are very efficient in collecting particles and many vehicles have a certain cleaning procedure at certain mileage intervals, wherein the filter is heated in order to try and remove the collected particles. However, even if some of the particles are burnt off during this procedure it is not so efficient as to completely clean the filters, and thus after a certain mileage the filter has to be replaced. The replacement of the filter is rather costly for the vehicle owner and the filter should be able to be used further if cleaned because the material of the filter, stainless steel and ceramics, have not been degraded during use, if the filter has not been exposed to physical damage, and thus the filter could be reconditioned. This would in turn mean cheaper spare parts for the owners as well as reduced use of material resources.

There is thus a need for an efficient method for cleaning particle filters and also for measuring the result of the cleaning for guaranteeing the function of the filter, which reconditioned filters could be used as spare parts.

### BRIEF DESCRIPTION OF THE INVENTION

The aim of the present invention is to provide a novel method and system for cleaning particle filters and subsequent measurement of the degree of cleanness.

This aim is obtained by the features of the independent patent claims. Preferable embodiments of the invention are subject of the dependent patent claims.

According to a main aspect of the invention it is characterised by a method of cleaning a particle filter, in particular for combustion engines, comprising the steps of: a) applying heat to the interior of the particle filter during a certain time period for burning the trapped particles, b) removing the burnt particles from the particle filter, c) measuring the particle filter, wherein the measurements are compared to values of a unused filter of the particular type, and if the measured values deviate from the values of the unused filter by a predetermined amount, steps a) to c) are repeated until the measured values are within an approval range.

According to another aspect of the invention, it further comprises the step of cooling the particle filter in a controlled manner after the heating step.

According to yet an aspect of the invention, the removal of burnt particles is performed during the heating step. Then preferably the removal of burnt particles is performed by blowing air into the particle filter.

According to another aspect of the invention, the amount of removed burnt particles is measured and if below a certain predetermined amount, the heating step is terminated.

According to a further aspect of the invention, the measuring step c) is performed by measuring the pressure drop over the particle filter.

Alternatively or in addition the measuring step c) is performed by filling the particle filter with smoke and thereafter measuring the opacity through the filter.

The advantages and benefits of the present invention are several. The heating process where the soot is burnt has proved to be very efficient for removing substantial amounts of particles that are trapped in the narrow filter spaces, far better than for example high pressure liquid injected into the filter. The heating process is also environmentally friendly because the waste from the process is just some ash. If liquid were to be used, the liquid then had to be cleaned after the operation. After the heating step, the filter is measured regarding the degree of cleanness, and if it is not sufficient, the heating step is repeated.

Preferably the burnt soot is removed from the filter during the process by injecting bursts of air. The heating step could be controlled and stopped by a number of parameters. For example, the step could be stopped after a certain time period, which has been set by empirical tests of heating particle filters for different time periods and measuring the amount of soot removed. The burnt soot that is ejected from the filter by the air bursts could also be used as a parameter for stopping the heating step, such that when the amount ejected after an air burst is below a certain amount, this is an indication of the degree of cleanness and the process is stopped.

In order to monitor and control the efficiency of the burning step, the filter is measured. A differential pressure measurement over the filter indicates the degree of cleanness as it is compared to the differential measurement of a clean, unused filter. Further an opacity measurement is also performed for detecting any possible cracks in the filter. For this, smoke is fed through the filter and the opacity is measured after the filter, and the measured opacity is compared to the opacity measurements of a clean, unused filter. Preferably both the differential pressure measurement and the opacity measurement are performed with the filter in one setup.

These and other aspects of and advantages with the present invention will become apparent from the following detailed description and from the accompanying drawings.

### BRIEF DESCRIPTION OF THE DRAWINGS

In the following detailed description of the invention, reference will be made to the accompanying drawings, of which

FIG. 1 shows a flow chart of the method according to the invention,

FIG. 2 shows schematically the burning process according to the invention,

FIG. 3 shows schematically an example of measuring setup, and

FIG. 4 shows schematically a test setup for particle filters for vehicles.

### DETAILED DESCRIPTION OF THE INVENTION

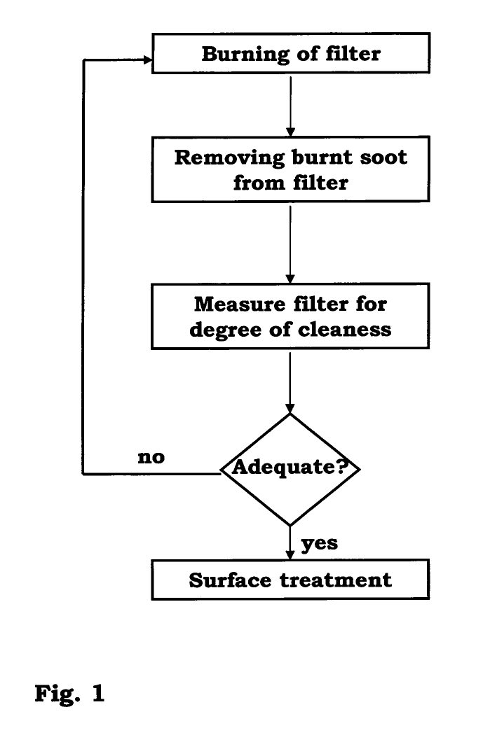

FIG. 1 shows a schematic flowchart of the method according to the present invention. The particles filters to be cleaned are first visually inspected for visual defects such as cracks, damaged fittings and the like. Then the filters are cleaned externally. This may be done by for example washing the exterior surface with hot water after all holes have been plugged. Any corrosion or other foreign matter not removed by the water is removed by blasting. Thereafter pipes and possible switches are removed as well as damaged bolts.

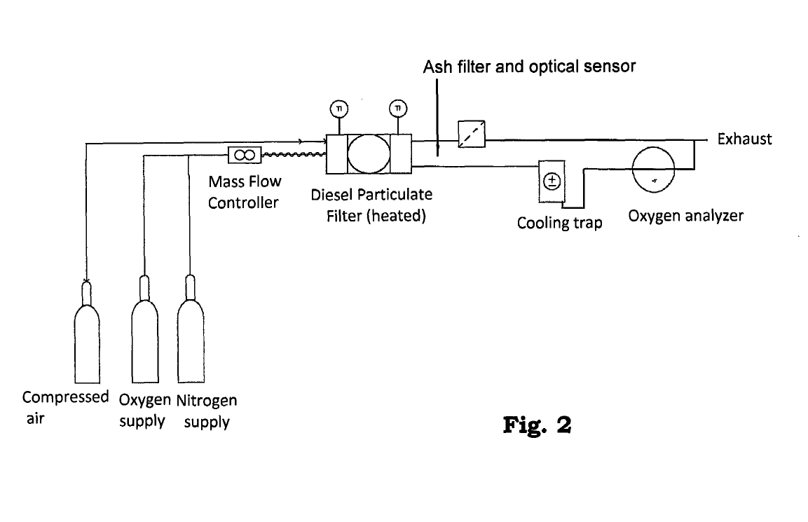

The next step is then to clean the interior of the particle filter. According to the present invention this is performed by burning off the soot and carbon compounds that have been deposited on the filter surfaces. FIG. 2 shows an example of a burning step. The particle filter is preferably first arranged with a wrapping of insulating heat-resistant material and is then connected to a gas supply. The O₂ content of the gas is preferably in the range 2-5%. A mass flow controller is arranged on the gas inlet conduit for controlling volume flow and composition. Then the gas is preferably preheated before entering the particle filter. The particle filter is heated to temperatures above the exothermic reaction of the soot when it is burnt off, but not too high, thereby avoiding damaging the ceramic filter surfaces. Temperature sensors are arranged to monitor the above temperatures. During this step the carbon compounds are burnt off the filter surfaces during which the volume flow and O₂ concentration are controlled depending on exhaust and inlet temperatures. The oxidation process is measured and monitored by the O₂ sensor and temperature control at filter front and in flowing gas stream.

It is of course to be understood that heated air may be used instead of oxygen and nitrogen gas and also in combination with pressurised air as will be explained below.

If the particle filter is combined with a catalyst in one unit, which could be the case for some vehicles, the burnt soot should not pass the catalyst. These types of units are often provided with a drainage passage in the filter casing leasing to a space between the filter and the catalyst. In this case the outlet of the unit is plugged and the drainage passage is opened, where the burnt soot can be removed.

The end of the oxidation process could be performed in a few different ways. The most simple is to end the heating after a predetermined time period, which time period is based on empiric studies of certain types of particle filter. Another way is to end the heating when exhaust O₂ concentration equals adjusted supply concentration.

A third way is to measure the amount of burnt particles during the heating process. In that aspect, the particle filter is subjected to bursts of air injection through it with certain time intervals. The air bursts cause the burnt particles to be ejected from the filter. The amount of particles could then be used as a measurement of when the burning process can be terminated.

There are of course other ways of heating the filters, and in particular in combination with more automated cleaning systems. For example larger containers or ovens that can house a large number of filters that are heated simultaneously in batches. There could also be suitable conveyor means that can move the filters into and out of the heating containers. Theses containers or ovens could be heated in many suitable ways, that are all within the scope of the person skilled in the art.

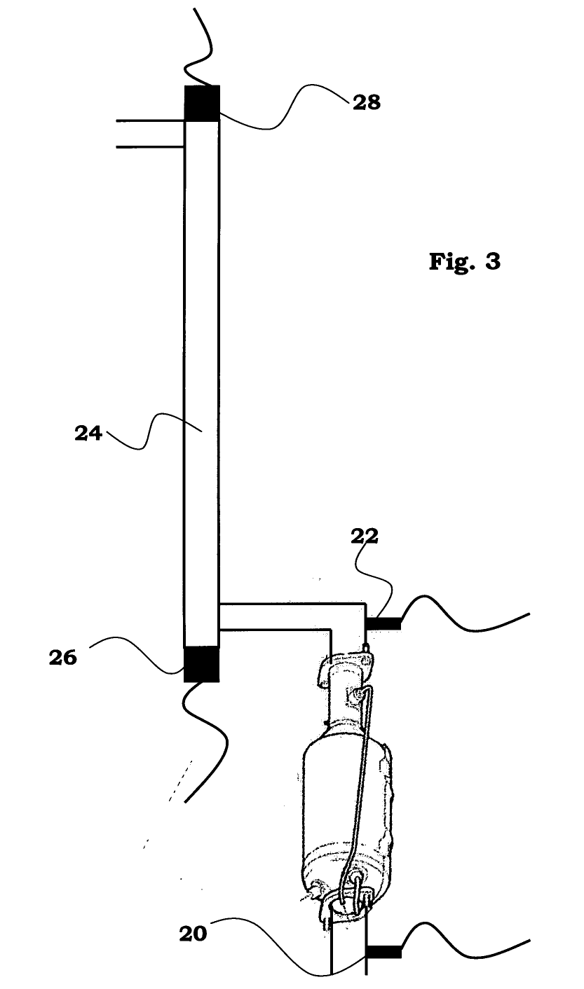

When the burning step is finished, the cleaning result has to be measured and evaluated. This may be done according to the present invention in a number of ways. FIG. 3 shows a schematic setup.

One way is to measure the differential pressure over the particle filter, where high values of the differential pressure is an indication of a dirty filter because the filter is clogged with soot and other carbon compounds. The measured differential pressure is compared with the differential pressure value of a clean unused filter of that particular type. Pressure sensors 20, 22 are then placed at the inlet and outlet of the filter and a pressure source (not shown) is used for applying pressure to the filter. The pressure sensors are connected to a suitable means for handling the signals from the sensors and to compare them with predetermined pressure values.

Another way of measuring the result of the heating process is to measure the opacity through the particle filter. The filter is in this instance connected to a straight pipe 24. The pipe is in one end arranged with a light transmitter 26, for example a powerful LED, and the other end is arranged with an optical receiver 28. The light transmitter is connected to suitable drive means for operating it and the optical receiver is connected to signal handling means. Smoke is then fed through the particle filter and then into the pipe until a stable concentration of gas is obtained. The opacity is then measured and compared to the values of a clean, unused filter. The opacity measurement gives an indication that the filter is cracked, giving high values. A combination of dirty filter having cracks can provide normal readings on the differential pressure measurements but will have high readings on the opacity measurements.

When a combined filter and catalyst is to be measured, the catalyst has to be ignited and heated in order to have the correct operating conditions.

Other measurement means could include laser scanner, and in particular for locating cracks and clogged channels in the filter. It is also feasible to use optical and/or image handling devices for inspecting the cleaning result inside the filter.

As mentioned above, the measured values are compared to pre-measured and preset values of a new filter. If the measured values deviate from the preset values with a certain amount, this indicates that the heating step has not been completely successful. In this case the filter is subjected to another heating step for further cleaning. After the heating step the filter is again measured as described above. This is repeated until the measured values are within an acceptable range compared to the preset values. It is of course to be understood that if a filter is cracked, no further heating processes will be done. In those cases the filter is either discarded or the location of the cracks is detected and the cracks are repaired.

When the filter is cleaned, it is moved to a finishing step where the filter is subjected to surface treatment and will be given a unique test number for later traceability of the particular filter.

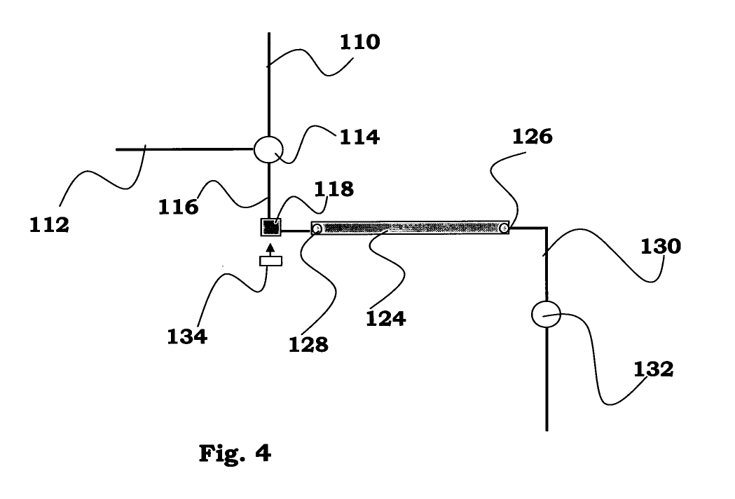

The test setup shown in FIG. 4 comprises two inlet pipes 110, 112 connected to a three way valve 114, where one of the inlet pipes 110 is connected to an air source and a fan (not shown) and the other is connected to a smoke generator (not shown). A further pipe 116 is connected to the three way valve. To this pipe an inlet of a particle filter 118 can be releasably attached.

The outlet of the filter is connected to a straight pipe 124. The pipe is in one end arranged with a light transmitter 126, for example a powerful LED, and the other end is arranged with an optical receiver 128. The light transmitter is connected to suitable drive means for operating it and the optical receiver is connected to signal handling means. An outlet pipe 130 is attached to one end of the straight pipe and arranged with a valve 132. A gas meter 134 is further arranged to the particle filter.

The system is intended to function as follows. The three way valve 114 is positioned such that the smoke inlet pipe 110 is connected to the further pipe 116. Smoke generated by the smoke generator is led through the inlet, filling the particle filter 118 and the straight pipe 124. The outlet valve 132 is closed.

The gas meter 134 is activated and measures gas content such as CO, CO₂, HC and O₂. The gas meter is also capable of checking if a catalyst is functioning, if the particle filter is combined with a catalyst, which some vehicles have.

The light source 126 is activated and when a stable concentration of gas is obtained the strength of the emitted light through the smoke-filled straight pipe is measured by the receiver 128 as a measure of the opacity. The measured opacity is then compared to the values of a clean, unused filter. The opacity measurement gives an indication that the filter is cracked, giving high values.

When the measurements have been performed, the three way valve 114 is positioned such that the air inlet 112 is connected to the further pipe and the outlet valve 132 is opened. The system is now cleaned from smoke and is ready for testing of a subsequent filter.

When a combined filter and catalyst is to be measured, the catalyst has to be ignited and heated in order to have the correct operating conditions.

Other measurement means could include laser scanner, and in particular for locating cracks and clogged channels in the filter. It is also feasible to use optical and/or image handling devices for inspecting the cleaning result inside the filter.

As mentioned above, the measured values are compared to pre-measured and preset values of a new filter. If the measured values deviate from the preset values with a certain amount, this indicates that a previous cleaning step has not been completely successful. In this case the filter is subjected to further cleaning.

Even though some examples of cleaning and test equipment have been mentioned above, it is to be understood that other types of equipment, systems and principles can be utilized for performing the method according to the invention. Therefore the embodiments described and shown in the figures are to be regarded as only non-limiting examples of the present invention and that it may be modified within the scope of the patent claims.

1. Method of cleaning a particle filter, in particular for combustion engines, comprising the steps of:
a) applying heat to the interior of the particle filter during a certain time period for burning the trapped particles,
b) removing the burnt particles from the particle filter,
c) measuring the particle filter, wherein the measurements are compared to values of a unused filter of the particular type, and
if the measured values deviate from the values of the unused filter by a predetermined amount, steps a) to c) are repeated until the measured values are within an approval range.

2. Method according to claim 1, wherein it further comprises the step of cooling the particle filter in a controlled manner after the heating step.

3. Method according claim 1, wherein the removal of burnt particles is performed during the heating step.

4. Method according to claim 3, wherein the removal of burnt particles is performed by blowing air into the particle filter.

5. Method according to claim 3, wherein the amount of removed burnt particles is measured and if below a certain predetermined amount, the heating step is terminated.

6. Method according to claim 1, wherein the measuring step c) is performed by measuring the pressure drop over the particle filter.

7. Method according to claim 1, wherein the measuring step c) is performed by filling the particle filter with smoke and thereafter measuring the opacity through the filter.

8. Method according to claim 7, wherein laser light is used.

9. System for cleaning a particle filter, in particular for combustion engines, comprising the means for applying heat to the interior of the particle filter during a certain time period for burning the trapped particles, means for removing the burnt particles from the particle filter, means for measuring the particle filter, wherein the measurements are compared to values of a unused filter of the particular type.

10. System according to claim 9, wherein it further comprises means for cooling the particle filter in a controlled manner after the heating step.

11. System according claim 9, wherein it further comprises means for removing burnt particles during the heating step.

12. System according to claim 11, wherein the means for removing of burnt particles comprises means for blowing air into the particle filter.

13. System according to claim 11, wherein it further comprises means for measuring the amount of removed burnt particles means for terminating the heating step if the amount is below a certain predetermined amount.

14. System according to claim 9, wherein the means for measuring the particle filter comprises means capable of measuring the pressure drop over the particle filter.

15. System according to claim 9, wherein the means for measuring the particle filter comprises means for filling the particle filter with smoke and means for measuring the opacity through the filter.

16. Method of testing a particle filter, in particular for combustion engines, that has been subjected to a cleaning process, comprising the steps of measuring the particle filter, wherein the measurements are compared to values of a unused filter of the particular type, and if the measured values deviate from the values of the unused filter by a predetermined amount, expose the particle filter to further treatment.

17. Method according to claim 16, wherein the measuring step is performed by filling the particle filter with smoke from a smoke generator and thereafter measuring the opacity through the filter.

18. Method according to claim 16, wherein laser light is used.

19. Method according to claim 17, wherein said filter is connected to a straight pipe downstream said smoke generator, which pipe has a certain predetermined length having a light transmitter in one end and a light receiver in the other end, wherein the pipe is filled with smoke at the same time as the filter, and that measurements are performed when a stable condition is established in the pipe.

20. Method according to claim 16, wherein it further comprises measuring gas content, such as CO, CO₂, HC, O₂.

21. Method according to claim 17, wherein it comprises the further step of removing the smoke after performed measurements.

22. System for testing a particle filter, in particular for combustion engines, that has been subjected to a cleaning process, comprising means for measuring the particle filter, and means for comparing the measurements to values of a unused filter of the particular type, and if the measured values deviate from the values of the unused filter by a predetermined amount, means for informing the condition.

23. System according to claim 22, wherein it comprises means for filling the particle filter with smoke from a smoke generator and thereafter measuring the opacity through the filter.

24. System according to claim 22, wherein said measuring means comprises laser light.

25. System according to claim 23, wherein it further comprises a straight pipe to which said filter is connectable, wherein said straight pipe is arranged downstream said smoke generator, which pipe has a certain predetermined length having a light transmitter in one end and a light receiver in the other end, wherein the pipe is filled with smoke at the same time as the filter, and that measurements are performed when a stable condition is established in the pipe.

26. System according to claim 22, wherein it further comprises means for measuring gas content, such as CO, CO₂, HC, O₂.

27. System according to claim 23, wherein it comprises means for removing the smoke after performed measurements.
